(19) United States
(12) Patent Application Publication
(10) Pub. No.: US 2020/0211099 A1
(43) Pub. Date: Jul. 2, 2020

(54) Decentralized Customer-Controlled Credit Verification

(71) Applicant: Finicity Corporation, Murray, UT (US)

(72) Inventors: Steven B. Smith, Murray, UT (US); Nicholas A. Thomas, Murray, UT (US)

(21) Appl. No.: 16/723,536

(22) Filed: Dec. 20, 2019

Related U.S. Application Data
(60) Provisional application No. 62/787,138, filed on Dec. 31, 2018.

(51) Int. Cl. G06Q 40/02; G06Q 20/36; G06Q 20/38; H04L 9/30; H04L 9/32

(52) U.S. Cl. CPC G06Q 40/02; G06Q 20/363; H04L 9/3218; G06Q 20/3829; H04L 9/3073; G06Q 20/3821

(57) ABSTRACT

Systems and methods for decentralized distribution of verifiable information, such as financial information, without requiring resort to centralized information system at the time of a query or other request for information. A decentralized method includes the steps of creating a digital wallet, issuing/receiving an issued verifiable digital credential signed by a credential issuer acting as a trust anchor for a claim contained in the verifiable digital credential, storing the verifiable digital credential within the digital wallet, receiving a request for verified information, and providing the verifiable digital credential, including the claim, from the digital wallet. The verification of information may occur as a zero-knowledge proof such that a required standard is verified as satisfied without disclosing more information about a consumer or other user than is absolutely necessary.

### CROSS-REFERENCED APPLICATIONS

This patent application claims priority to U.S. Provisional Patent Application No. 62/787,138, which was filed on Dec. 31, 2018.

### BACKGROUND OF THE INVENTION

### 1. Field of the Invention

The present invention relates to consumer reporting, and more particularly to systems and methods for providing decentralized customer-controlled credit verification.

### 2. Background and Related Art

Traditionally, a number of centralized consumer reporting agencies have been responsible for providing credit verification services as a part of the credit decision-making process. Would-be consumers/borrowers approach would-be lenders about obtaining a loan, credit line, or other type of credit, and the would-be lenders obtain information about the potential borrower. The lender then uses the borrower information to contact one of the several consumer reporting agencies to request information or credit verification sufficient to allow the lender to determine whether to extend the requested credit to the potential borrower or not, what limit or limits to set on any credit extended to the potential borrower, and/or a rate to be applied to any credit extended to the potential borrower.

To facilitate such decision-making, the various consumer reporting agencies obtain and control data relevant to consumers' credit worthiness, such as account data, payment history and overdue amounts. Traditionally, the data stored by the consumer reporting agencies is opaque to the consumer, and the consumer has little ability to view, let alone control, the data maintained by the consumer reporting agencies. While consumer reporting agencies are required by the Fair Credit Reporting Act to timely correct mistakes contained within their stores of consumer data, such mistakes can prevent consumers from obtaining credit in a timely fashion and on the best terms.

Additionally, the consumer has little to no control over the personal information stored by the consumer reporting agencies, and the information provided by the consumer reporting agencies in response to credit inquiries. Data breaches have occurred at times, putting consumers' information and creditworthiness at risk. Furthermore, the data stored by the consumer reporting agencies and provided to lenders at a time of credit inquiry is often greater than is strictly necessary for the decision-making process related to the original credit inquiry. When lenders obtain more personal information about consumers than is strictly necessary for the lending process, that information becomes subject to added risks, such as data breaches of systems other than the systems of the consumer reporting agencies.

In addition to these problems, the consumer information at any one consumer reporting agency may differ from the consumer information at other consumer reporting agencies. This presents a problem, such as when a consumer takes the time to verify information at one agency only to have a lender obtain creditworthiness information from a different, unverified, agency. A possible result of agency differences in data can be a surprise variation from expected credit application results, such as credit denial, increased loan interest rates, or other negative consequences to the lender or the consumer.

Accordingly, there are significant difficulties inherent in the current centralized or semi-centralized system for creditworthiness verification. Lenders, however, are understandably wary of propositions that would decentralize maintenance of creditworthiness information. Lenders need to be able to trust that the information they receive and use in the credit decision-making process is verified and trustworthy, and that credit determinations made on such data will not result in monetary losses to the lender due to bad information. Furthermore, a decentralized information system could result in delays in the decision making process if lenders are unable to obtain trusted information in a timely fashion. Accordingly, there have been significant impediments to adoption of any kind of decentralized system.

### BRIEF SUMMARY OF THE INVENTION

Implementations of the invention provide systems and methods for decentralized distribution of verifiable information, such as financial information, without requiring resort to a centralized information system at the time of a query or other request for information. Implementations of the invention may be realized as systems, methods, and as non-transitory computer-readable media for implementing methods discussed herein. According to exemplary implementations, a decentralized method for providing a verification of a consumer's creditworthiness without resort to a centralized credit bureau includes the steps of creating a digital wallet operating on a consumer computing device that includes a processor and non-transient memory store, receiving an issued verifiable digital credential signed by a credential issuer acting as a trust anchor for a claim regarding a consumer's creditworthiness contained in the verifiable digital credential, storing the verifiable digital credential within the digital wallet, receiving a request for a verification of the consumer's creditworthiness from a lender, and providing the verifiable digital credential, including the claim regarding the consumer's creditworthiness, to the lender using the digital wallet.

In some implementations, the method includes a step of generating a consent receipt recording how information disclosed by the creditor will be used. In some implementations, the method includes a step of creating a consumer identification to serve as a decentralized identifier for the consumer. In some implementations creating a consumer identification is performed by the digital wallet. In some implementations, creating a consumer identification is performed by the centralized credit bureau, and the consumer identification is transmitted to the digital wallet.

In some implementations, the claim regarding the consumer's creditworthiness includes a verified credit score. In some implementations, the claim regarding the consumer's creditworthiness includes a verification that the consumer's credit score exceeds a minimum value. In certain implementations, the claim regarding the consumer's creditworthiness includes a zero-knowledge proof that the consumer's credit score exceeds a minimum value. In further implementations, the claim regarding the consumer's creditworthiness includes a zero-knowledge proof that the consumer has a bank balance in excess of a minimum value. In some implementations, the claim regarding the consumer's creditworthiness includes a zero-knowledge proof that the consumer has an income in excess of a minimum value.

According to further implementation of the invention, a decentralized method for providing a verification of a consumer's creditworthiness that permits the consumer to verify creditworthiness without resort to a centralized credit bureau at a time of verification includes steps of receiving, at a centralized credit bureau computer that is connected to a global network and that includes a processor, a login request from a new consumer, creating a digital wallet for the new consumer using the processor, delivering the digital wallet to the consumer over a network connection, creating a consumer reporting agency (CRA) credential for the new consumer including a public-private key pair for a relationship between the CRA and the new consumer, registering a new identifier on a trust network for the new consumer, obtaining permission from the new consumer to share one or more claims sufficient to satisfy a lender request for a verification of the new consumer's creditworthiness, issuing and digitally signing a verifiable digital credential containing a claim regarding the consumer's creditworthiness, and delivering the claim regarding the consumer's creditworthiness to the digital wallet over the network connection such that the claim is available in the consumer's digital wallet for use on demand by the consumer.

In some implementations, the method includes steps of receiving permission from the new consumer over the global network to obtain information from a financial institution at which the new consumer has a financial account, and using the permission from the new consumer to access the financial institution and obtain information regarding the new consumer's financial account. In some implementations, the method includes using the information regarding the new consumer's financial account to generate the claim regarding the consumer's creditworthiness, wherein the claim regarding the consumer's creditworthiness includes a claim regarding income of the consumer. In some implementations, the method includes using the information regarding the new consumer's financial account to generate the claim regarding the consumer's creditworthiness, wherein the claim regarding the consumer's creditworthiness includes a claim regarding an account balance of the consumer.

In some implementations, the claim regarding the consumer's creditworthiness includes a zero-knowledge proof that the consumer's credit score exceeds a minimum value. In some implementations the claim regarding the consumer's creditworthiness includes a zero-knowledge proof that the consumer's income exceeds a minimum value. In some implementations, the claim regarding the consumer's creditworthiness includes a zero-knowledge proof that an account balance of the consumer exceeds a minimum value.

According to still further implementations of the invention, a method for providing a verified zero-knowledge proof in response to a query includes steps of receiving, at a user computing device having access to a digital wallet, a request for proof of information regarding a user, using the user computer device to obtain permission from the user to provide a verifiable proof of information regarding the user, accessing a response satisfactory to the requirements of the request for proof of information, wherein the response is cryptographically signed by a data issuer capable of verifying the information contained in the response, and transmitting the response from the user computing device to a receiving device operated by an issuer of the request for proof of information regarding the user.

In some implementations, the response satisfactory to the requirements of the request for proof of information is previously obtained and stored within the digital wallet. In some implementations, the response satisfactory to the requirements of the request for proof of information includes information such as verification of an age of the user, verification that an age of the user exceeds a certain minimum, verification that an age of the user is less than a certain maximum, verification of a credit score of the user, verification that a credit score of the user exceeds a certain minimum, verification of an income of the user, verification that an income of the user exceeds a certain minimum value, verification of an account balance of the user, verification that an account balance of the user exceeds a certain minimum value, verification of a value of assets of the user, or verification that a value of assets of the user exceeds a certain minimum value.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows a representative computing environment for use with embodiments of the invention;

FIG. 2 shows a representative networked computing environment for use with embodiments of the invention;

FIG. 3 shows an individual connection between two peers in a trust network supported by a distributed ledger (hyperledger) or blockchain;

FIG. 4 shows a triangle of trust relationship and an exchange of verifiable credentials among a credential issuer, a credential holder, and a credential verifier;

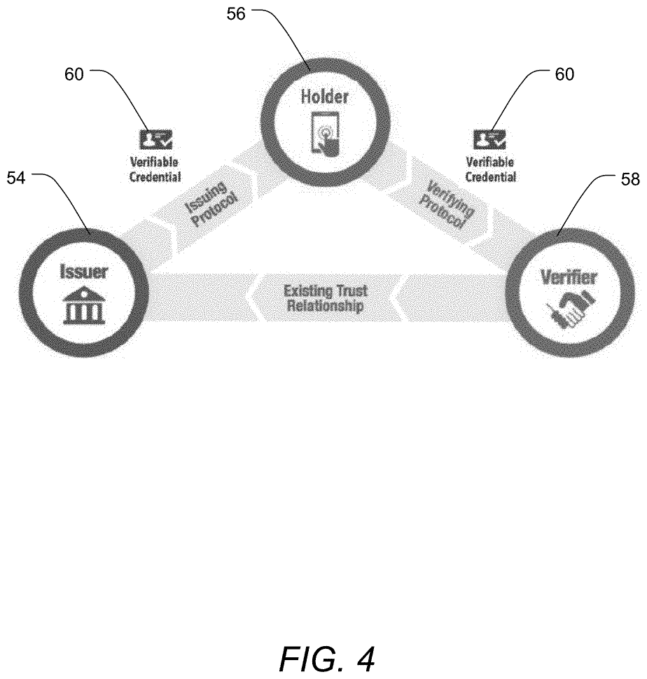

FIG. 5 shows connections between peers in a trust network supported by decentralized identifiers and by a distributed ledger or other decentralized network (trust web);

FIG. 6 shows a depiction of a trust network made up of connections between trust hubs, trust anchors, and identity owners; and

FIG. 7 depicts an exemplary method for providing decentralized consumer-controlled disclosure of financial information as part of a credit decision-making process.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

Embodiments of the invention provide systems and methods for decentralized distribution of verifiable information, such as financial information, without requiring resort to centralized information system at the time of a query or other request for information. Embodiments of the invention may be realized as systems, methods, and as non-transitory computer-readable media for implementing methods discussed herein. According to exemplary embodiments, a decentralized method for providing a verification of a consumer's creditworthiness without resort to a centralized credit bureau includes steps of creating a digital wallet operating on a consumer computing device that includes a processor and non-transient memory store, receiving an issued verifiable digital credential signed by a credential issuer acting as a trust anchor for a claim regarding a consumer's creditworthiness contained in the verifiable digital credential, storing the verifiable digital credential within the digital wallet, receiving a request for a verification of the consumer's creditworthiness from a lender, and providing the verifiable digital credential, including the claim regarding the consumer's creditworthiness, to the lender using the digital wallet.

In some embodiments, the method includes a step of generating a consent receipt recording how information disclosed by the creditor will be used. In some embodiments, the method includes a step of creating a consumer identification to serve as a decentralized identifier for the consumer. In some embodiments creating a consumer identification is performed by the digital wallet. In some embodiments, creating a consumer identification is performed by the centralized credit bureau, and the consumer identification is transmitted to the digital wallet.

In some embodiments, the claim regarding the consumer's creditworthiness includes a verified credit score. In some embodiments, the claim regarding the consumer's creditworthiness includes a verification that the consumer's credit score exceeds a minimum value. In certain embodiments, the claim regarding the consumer's creditworthiness includes a zero-knowledge proof that the consumer's credit score exceeds a minimum value. In further embodiments, the claim regarding the consumer's creditworthiness includes a zero-knowledge proof that the consumer has a bank balance in excess of a minimum value. In some embodiments, the claim regarding the consumer's creditworthiness includes a zero-knowledge proof that the consumer has an income in excess of a minimum value.

According to further embodiment of the invention, a decentralized method for providing a verification of a consumer's creditworthiness that permits the consumer to verify creditworthiness without resort to a centralized credit bureau at a time of verification includes steps of receiving, at a centralized credit bureau computer that is connected to a global network and that includes a processor, a login request from a new consumer, creating a digital wallet for the new consumer using the processor, delivering the digital wallet to the consumer over a network connection, creating a consumer reporting agency (CRA) credential for the new consumer including a public-private key pair for a relationship between the CRA and the new consumer, registering a new identifier on a trust network for the new consumer, obtaining permission from the new consumer to share one or more claims sufficient to satisfy a lender request for a verification of the new consumer's creditworthiness, issuing and digitally signing a verifiable digital credential containing a claim regarding the consumer's creditworthiness, and delivering the claim regarding the consumer's creditworthiness to the digital wallet over the network connection such that the claim is available in the consumer's digital wallet for use on demand by the consumer.

In some embodiments, the method includes steps of receiving permission from the new consumer over the global network to obtain information from a financial institution at which the new consumer has a financial account, and using the permission from the new consumer to access the financial institution and obtain information regarding the new consumer's financial account. In some embodiments, the method includes using the information regarding the new consumer's financial account to generate the claim regarding the consumer's creditworthiness, wherein the claim regarding the consumer's creditworthiness includes a claim regarding income of the consumer. In some embodiments, the method includes using the information regarding the new consumer's financial account to generate the claim regarding the consumer's creditworthiness, wherein the claim regarding the consumer's creditworthiness includes a claim regarding an account balance of the consumer.

In some embodiments, the claim regarding the consumer's creditworthiness includes a zero-knowledge proof that the consumer's credit score exceeds a minimum value. In some embodiments the claim regarding the consumer's creditworthiness includes a zero-knowledge proof that the consumer's income exceeds a minimum value. In some embodiments, the claim regarding the consumer's creditworthiness includes a zero-knowledge proof that an account balance of the consumer exceeds a minimum value.

According to still further embodiments of the invention, a method for providing a verified zero-knowledge proof in response to a query includes steps of receiving, at a user computing device having access to a digital wallet, a request for proof of information regarding a user, using the user computer device to obtain permission from the user to provide a verifiable proof of information regarding the user, accessing a response satisfactory to the requirements of the request for proof of information, wherein the response is cryptographically signed by a data issuer capable of verifying the information contained in the response, and transmitting the response from the user computing device to a receiving device operated by an issuer of the request for proof of information regarding the user.

In some embodiments, the response satisfactory to the requirements of the request for proof of information is previously obtained and stored within the digital wallet. In some embodiments, the response satisfactory to the requirements of the request for proof of information includes information such as verification of an age of the user, verification that an age of the user exceeds a certain minimum, verification that an age of the user is less than a certain maximum, verification of a credit score of the user, verification that a credit score of the user exceeds a certain minimum, verification of an income of the user, verification that an income of the user exceeds a certain minimum value, verification of an account balance of the user, verification that an account balance of the user exceeds a certain minimum value, verification of a value of assets of the user, or verification that a value of assets of the user exceeds a certain minimum value.

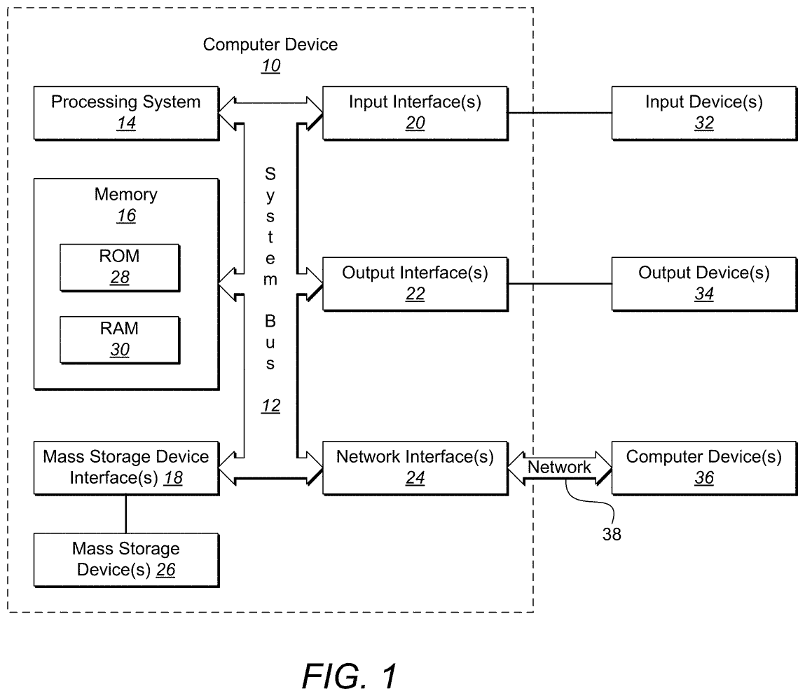

FIG. 1 and the corresponding discussion are intended to provide a general description of a suitable operating environment in which embodiments of the invention may be implemented. One skilled in the art will appreciate that embodiments of the invention may be practiced by one or more computing devices and in a variety of system configurations, including in a networked configuration. However, while the methods and processes of the present invention have proven to be particularly useful in association with a system comprising a general purpose computer, embodiments of the present invention include utilization of the methods and processes in a variety of environments, including embedded systems with general purpose processing units, digital/media signal processors (DSP/MSP), application specific integrated circuits (ASIC), stand alone electronic devices, and other such electronic environments.

Embodiments of the present invention embrace one or more computer-readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer-readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system. While embodiments of the invention embrace the use of all types of computer-readable media, certain embodiments as recited in the claims may be limited to the use of tangible, non-transitory computer-readable media, and the phrases “tangible computer-readable medium” and “non-transitory computer-readable medium” (or plural variations) used herein are intended to exclude transitory propagating signals per se.

With reference to FIG. 1, a representative system for implementing embodiments of the invention includes computer device 10, which may be a general-purpose or special-purpose computer or any of a variety of consumer electronic devices. For example, computer device 10 may be a personal computer, a notebook or laptop computer, a netbook, a personal digital assistant (“PDA”) or other hand-held device, a smart phone, a tablet computer, a workstation, a minicomputer, a mainframe, a supercomputer, a multi-processor system, a network computer, a processor-based consumer electronic device, a computer device integrated into another device or vehicle, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer-readable media, such as on memory 16, a magnetic hard disk, a removable magnetic disk, a magnetic cassette, an optical disk, or from a communication connection, which may also be viewed as a computer-readable medium.

Memory 16 includes one or more computer-readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer-readable medium. Mass storage devices 26 and their corresponding computer-readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), an integrated circuit, a firewire (IEEE 1394), or another interface. For example, in some embodiments input interface 20 includes an application specific integrated circuit (ASIC) that is designed for a particular application. In a further embodiment, the ASIC is embedded and connects existing circuit building blocks.

One or more output interfaces 22 may be employed to connect one or more corresponding output devices 34 to system bus 12. Examples of output devices include a monitor or display screen, a speaker, a printer, a multi-functional peripheral, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

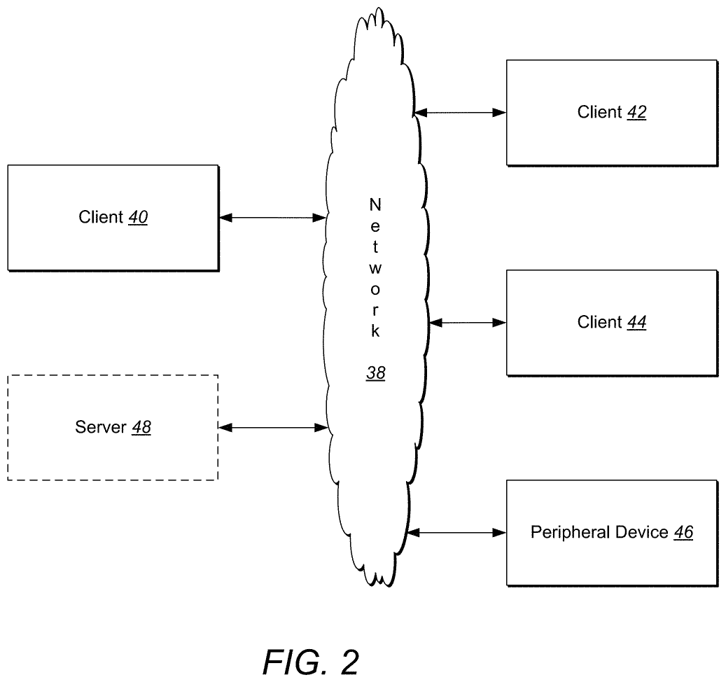

Thus, while those skilled in the art will appreciate that embodiments of the present invention may be practiced in a variety of different environments with many types of system configurations, FIG. 2 provides a representative networked system configuration that may be used in association with embodiments of the present invention. The representative system of FIG. 2 includes a computer device, illustrated as client 40, which is connected to one or more other computer devices (illustrated as client 42 and client 44) and one or more peripheral devices 46 across network 38. While FIG. 2 illustrates an embodiment that includes a client 40, two additional clients, client 42 and client 44, one peripheral device 46, and optionally a server 48, which may be a print server, connected to network 38, alternative embodiments include more or fewer clients, more than one peripheral device 46, no peripheral devices 46, no server 48, and/or more than one server 48 connected to network 38. Other embodiments of the present invention include local, networked, or peer-to-peer environments where one or more computer devices may be connected to one or more local or remote peripheral devices. Moreover, embodiments in accordance with the present invention also embrace a single electronic consumer device, wireless networked environments, and/or wide area networked environments, such as the Internet.

Similarly, embodiments of the invention embrace cloud-based architectures where one or more computer functions are performed by remote computer systems and devices at the request of a local computer device. Thus, returning to FIG. 2, the client 40 may be a computer device having a limited set of hardware and/or software resources. Because the client 40 is connected to the network 38, it may be able to access hardware and/or software resources provided across the network 38 by other computer devices and resources, such as client 42, client 44, server 48, or any other resources. The client 40 may access these resources through an access program, such as a web browser, and the results of any computer functions or resources may be delivered through the access program to the user of the client 40. In such configurations, the client 40 may be any type of computer device or electronic device discussed above or known to the world of cloud computing, including traditional desktop and laptop computers, smart phones and other smart devices, tablet computers, or any other device able to provide access to remote computing resources through an access program such as a browser.

Embodiments of the invention may be implemented in conjunction with a decentralized peer-to-peer system of trusted relationship between people, organizations, or connected things. By way of example, the Sovrin Foundation (https://sovrin.org) provides such a peer-to-peer system and architecture on which or through which embodiments of the invention may be implemented. The Sovrin architecture accomplishes its purpose through its constitution, the Sovrin Trust Framework, which lays out its purpose as providing a global public utility for self-sovereign identity adhering to a set of thirteen principles: independence and self-sovereignty, guardianship, diffuse trust, web of trust, system diversity, interoperability, portability, security by design, privacy by design, accountability, openness, identity for all, and collective best interest. Sovrin's embrace of these principles allows it to meet the needs of identity owners and protect their data, privacy, and autonomy. These principles guide the development of the Sovrin code and the operational rules for stewards, the trusted organizations who operate validator nodes and connect to Sovrin's ledger in a transparent way.

Sovrin provides a documented public governing agreement, and the process for amending the Sovrin Trust Framework is also public. The public nature of the agreement and process ensures that Sovrin continues to be public and open to all, and is technically, politically, and geographically decentralized to achieve diffuse trust and diffuse control. Any organization that wishes to run a node on the Sovrin Network can qualify to become a steward by following the rules defined in the trust framework. Stewards currently include countries, non-governmental organizations, law firms, credit unions and banks, self-sovereign startups, universities, and digital certificate authorities.

Sovrin's architecture supports independent software agents to hold and process claims as well as to perform identity transactions on the identity owner's behalf. These agents interoperate directly with each other as peers. Sovrin specifies the protocols that agents use so that agents from different vendors can work together and to support substitutability.

Sovrin's decentralized identifiers (DIDs) are identifiers intended for self-sovereign, verifiable digital identities to prevent correlation, one of the major concerns of conventional identity systems. Sovrin is built from the ground up using pairwise pseudonymous identifiers to separate data from direct identifiers and reduce correlation.

In Sovrin, mutually authenticated connections are built into every relationship. For example—when an identity holder uses Sovrin to authenticate with their bank, the bank knows it's them and the identity holder know it's the bank. Rather than an asymmetric relationship where one side uses cryptographic means to authenticate itself and the other uses a mishmash of usernames and passwords, both sides symmetrically use cryptographic technology to authenticate the other.

The Sovrin Network uses a purpose-built distributed ledger, technology frequently known as blockchain, to enable the exchange of cryptographically signed credentials. The diffuse trust model embodied in the Sovrin Network promotes independence and enhances protection from outside interference, further placing individuals in control of their identities and at the center of their digital interactions.

The infrastructure for ensuring consensus for identity transactions on the Sovrin Network is provided by carefully vetted group stewards who independently own and operate their nodes on the network. Stewards work together to form a system of checks and balances.

The Sovrin Foundation is a non-profit. It doesn't represent that it actually owns the network; no one owns it, but anyone can build on it, much like the Internet itself. The Sovrin Network is public: everyone can use Sovrin to establish their own digital identity, linking it to credentials from multiple sources, including governments, companies, individuals, and others.

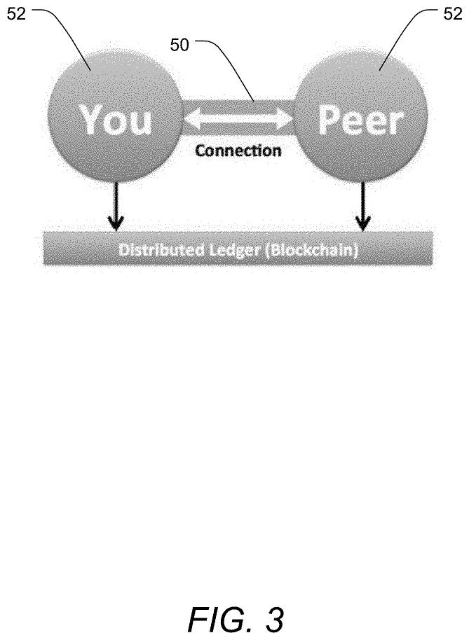

The Sovrin Network provides a web of trust formed by connections 50 between two peers 52 as shown in FIG. 3. Each connection 50 may be formed through the exchange of pairwise pseudonymous decentralized identifiers (DIDs), each of which represents a pairwise pseudonymous cryptographic key pair and a pairwise agent endpoint.

By itself, each Sovrin connection 50 only creates a basic level of cryptographic trust between the two peers 52. It does not automatically infer human trust of any kind. Trust at the human level is established via the exchange of verifiable digital credentials between a “trust triangle” of credential issuers 54, credential holders (identity owners) 56, and verifiers 58 (e.g., a lender in a case of an application for credit). A verifiable credential 60 contains one or more claims that the issuer 54 asserts are true about the identity owner/holder 56. Accordingly, the verifiable credential 60 acts in a fashion similar to the identity credentials typically carried in a wallet or purse, such as a passport, driver's license, health insurance card, credit card, or the like.

When a new connection 50 is established, the verifier 58 can make a proof request of the holder 56 for the claims needed to establish the desired level of assurance. The proof request can also specify the issuer 54 or issuers 54 that the verifier 58 trusts to provide the claims. The holder 56 can then satisfy the proof request by returning one or more verifiable proofs of the requested claims (e.g. the verifiable credential 60) from qualified issuers 54, including proof of non-revocation and proof of agent authorization.

In some instances, trust needs to be established across more than one connection 50. If, for example, a holder 56 presents a verifiable credential 60 from an issuer 54 that the verifier 58 does not know directly, the verifier 58 may require a second verifiable credential 60 describing that issuer 54. This may be accomplished by forming trust chains of issuers 54 issuing verifiable credentials 60 to other issuers 54. From a public key infrastructure (PKI) standpoint, this is analogous to the chain of trust established between certificate authorities signing intermediate certificates. Sovereign trust chains, however, are formed between public DIDs identifying each issuer 54 such that they are dynamically verifiable and revocable using the Sovrin infrastructure. The “certificates” equate to the verifiable credentials 60. The nature and scope of each trust relationship in the trust chain can depend on the verifiable credential 60 being issued or on the trust framework defining the verifiable credential 60.

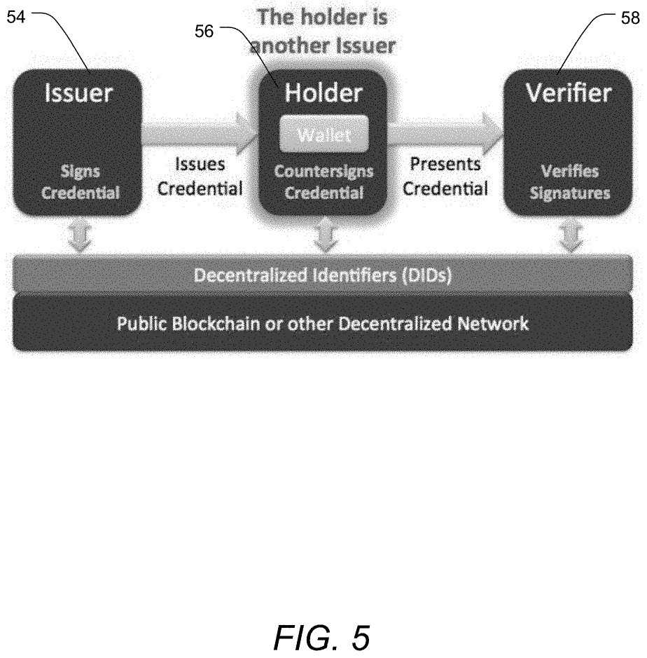

Trust chains can be as long as needed. In practice, however, trust chains tend to be only two to three connections 50 deep to streamline verification and to maximize accountability. FIG. 5 illustrates one example of a trust chain involving a single issuer 54, holder 56 (who acts as another issuer), and verifier 58.

The issuer 54 who is considered authoritative for a particular claim is called a trust anchor for that claim. Trust anchors must be Sovrin stewards. By way of example, a bank could be a trust anchor for a bank account balance. A post office could be a trust anchor for a mailing address. A university could be a trust anchor for a diploma. The trust anchor serves as the starting point in the trust chain, the root of trust, and when the verifier 58 receives verification of a particular claim from the trust anchor, the verifier 58 needs look no further and can consider a particular claim verified.

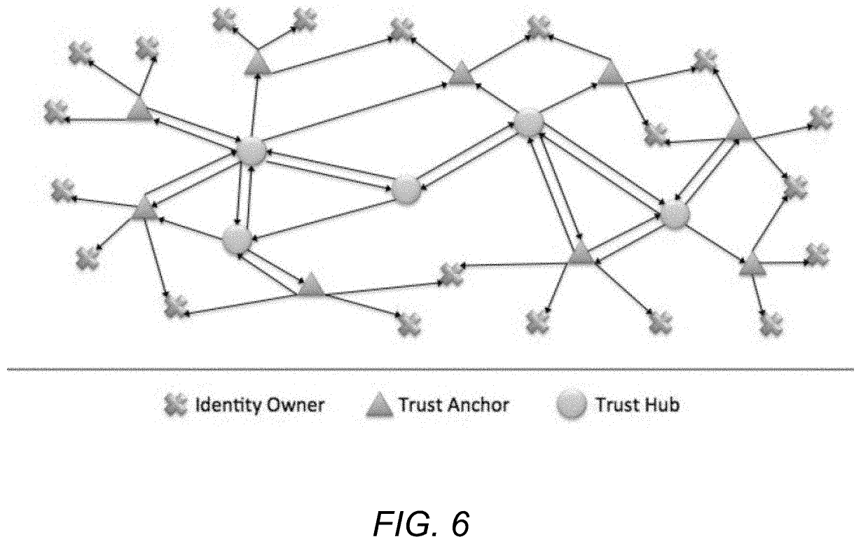

Of course, verifiers 58 need to know what trust anchors to trust for what claims. The Sovereign model of a web of trust provides two solutions to the problem: trust hubs and trust frameworks. Trust hubs organized as a trust network are illustrated in FIG. 6. The trust hubs are issuers 54 who issue trust anchor credentials to the trust anchors for a particular set of claims or credentials. The group of trust anchors connected by a trust hub forms a trust network. Sovrin trust anchors, trust hubs, and trust networks form a web, not a hierarchy. Accordingly, there may be any number of trust networks in the web, each with any number of trust hubs and trust anchors. Trust relationships are not unidirectional: trust hubs may use verifiable credentials 60 to cross-certify each other, and trust anchors may verify trust hubs.

There may be any number of exemplary natural trust hubs and trust networks. For example, the U.S. Federal Reserve may serve as a trust hub for the network of all FDIC-insured banks. Visa may serve as a trust hub for the issuing banks in the Visa network and MasterCard for the issuing banks in the MasterCard network. The Council for Higher Education Accreditation (CHEA) may serve as a trust hub for educational accreditation bodies and ministries of education in many countries. CULedger may serve as a trust hub for credit unions in the CULedger network. A chamber of commerce may serve as a trust hub for its registered businesses. The Financial Data Exchange may serve as a trust hub for members of the FDX Special Interest Group.

A trust framework is a set of business, legal, and technical policies, specifications, and contracts that govern a trust network. This governance may be instituted as a standard form contract entered into by all members of the network. The trust framework acts as the constitution of the trust network. The Sovrin Network is itself a trust network for operation of the Sovrin public ledger, in which the Sovrin Foundation is the trust hub, the Sovrin stewards are the trust anchors, and the Sovrin Trust Framework is the trust framework. While most work in Sovrin can be done by any identity, a few operations are specially defined in and limited by the Sovrin Trust Framework: only trust hubs (trustees) can add a steward, only stewards can add a node, and only trust anchors can add a DID.

The Sovrin Network and the Sovrin Trust Framework can serve as an infrastructure for other trust networks, acting as a substrate for domain-specific trust frameworks. Domain-specific trust frameworks may be dedicated to specific sectors and/or geographic regions. Any digital credential intended to serve more than one issuer 54 and verifier 58 needs a domain-specific trust framework. As one example, CULedger is a consortia created to build blockchain solutions for the credit union industry and its worldwide members. MyCUID is an initiative of CULedger, a global digital credential of credit union membership. MyCUID has developed a domain-specific trust framework on Sovrin.

Another domain-specific trust framework may serve to govern business, legal, and technical policies, schema specifications, and contracts in a Sovrin-enabled financial data sharing ecosystem. The financial data sharing ecosystem focuses on putting the consumer in control of their raw data and the credentials/objectics generated using their data.

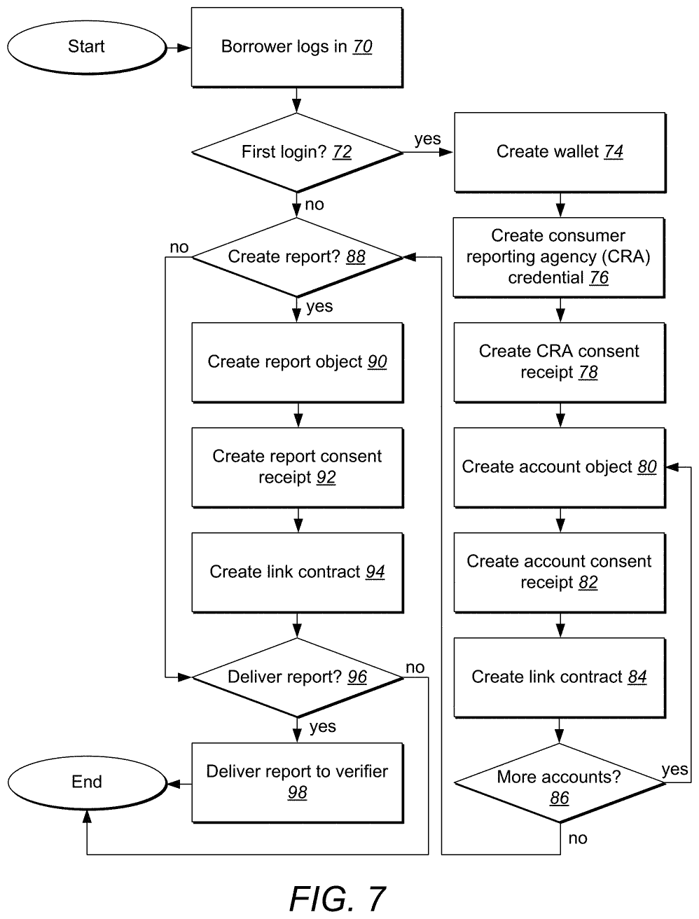

According to embodiments of the invention, as illustrated in FIG. 7, a borrower can log in to a financial data sharing ecosystem operating on the domain-specific trust framework operating on the Sovrin Network (or similar network/system) at step 70. The borrower may log in to the financial data sharing ecosystem at any lender leveraging the solution. When a borrower logs in for the first time, as determined at decision block 72, a digital borrower wallet may be created either automatically or at the request of the borrower, at step 74. The wallet may be created by the trust hub or trust anchor, such as by a consumer reporting agency (CRA) serving as the trust hub or trust anchor.

After the wallet is created, the system may create a consumer identification to serve as a decentralized identifier (DID) for the consumer. As a first step, a CRA credential may be created at step 76. In this step, a new Sovrin public-private key pair is generated for the relationship between the CRA and the consumer. The wallet or CRA system can then generate and register a new identifier on Sovrin for the consumer. This identifier can be used by, for example, lenders to create an account for the consumer at a later stage. The CRA could then determine which claims can be used to satisfy any request by the lender and can obtain permission from the consumer to share such claims, as will be discussed in more detail below. At step 78, a CRA consent receipt may be generated that records how the consumer's disclosed information will be used, such as by the CRA.

To facilitate association of beneficial financial data about the consumer with the wallet, the consumer may then be provided with an opportunity to provide information about his or her financial accounts, which information may be used later in generation of one or more reports relating to the consumers creditworthiness for provision to the lender, as will be discussed in more detail below. In some embodiments, the consumer reporting agency is able to act as a data aggregator, and based on its connections with financial institutions within the domain-specific trust framework and network, the consumer reporting agency is able to obtain permission from the consumer to obtain information necessary for the desired report from the financial institution or institutions at which the consumer has accounts.

Accordingly, the consumer may be provided with an opportunity to input financial account information into the wallet. This process encompasses creation of an account object at step 80, based on entry of the user's financial account information, which may include financial institution information, routing and account numbers, username and password information, or any other identifying information that permits access to necessary account information. Alternatively, the user may provide verifiable credentials 60 already in his or her possession and any necessary permissions which may be used within the domain-specific trust framework to obtain information from the financial institution or financial institutions without requiring disclosure of identifying account information.

As with creation of the wallet, upon entry of the account information (or the relevant verifiable credential 60), a new Sovern public-private key pair may be generated for the relationship between the user's accounts at the financial institution and the CRA/digital wallet permitting obtaining of relevant information for a permissioned period of time or, alternatively, indefinitely. A new identifier on Sovrin can then be generated, which can be used to permit obtaining of information from the financial institution during report generation. At step 82, an account consent receipt may be generated that records how the consumer's disclosed account information will be used, such as by the CRA or the wallet in generating necessary reports as discussed below. Additionally, a link contract may be created at step 84, which link contract governs access to consumer data and reports in the manner consented by the consumer.

As may be appreciated, consumers may have multiple accounts that may be relevant to creditworthiness determinations. Accordingly, a determination may be made at decision block 86 as to whether to add additional accounts into the system. If yes, execution loops back to step 80 for creation of additional account objects. If not, execution proceeds to decision block 88, where a determination is made as to whether a report is to be generated (e.g. to satisfy a creditworthiness inquiry from the lender). On subsequent login actions, execution may proceed directly to decision block 88 without performing the steps of creating a digital wallet and adding account information.

If a report is to be generated, execution proceeds to step 90, where a report object is generated. The report object is generated based on the information requested or required by the lender to make the creditworthiness determination. By way of example, the required or requested information may include information such as a verification of assets, a verification of income, a mortgage payoff report, a credit score, a report of overall indebtedness, and the like. The report may include any desired level of detail regarding the consumer's financial information, but in some embodiments of the invention the consumer is able to control or limit the information that is contained in the generated report.

By way of example, in some instances the information contained in the report is limited so as to protect against unwanted disclosure of the consumer's financial or personal information. In some embodiments, the financial information contained in the report may be scrubbed to remove identifying information, while the report still contains a verifiable credential 60 by which the lender is able to verify or confirm that the report pertains to the consumer, is accurate, and is trustworthy. In some embodiments, the report or the financial information contained in the report may be limited to a verified query answer, such as a verified credit score, without allowing the lender (verifier 58) access to underlying data used to create the verified query answer (e.g., credit score). Such embodiments may further protect the consumer's personal and financial information against unwanted disclosure. In a more-stringent example, the verified query answer may be further limited to a binary answer (e.g., a yes-or-no response to a query, such as, “Is the consumer's credit score above ______ [some baseline value for extending credit]?” or “Does the consumer have a savings balance in excess of ______?”

This last example is one example of a zero-knowledge proof. Zero-knowledge proofs include any proofs of questions that can be answered and verified by a cryptographic signature of a data issuer without disclosing underlying information that is more than the minimum necessary to answer the questions. Typical examples include questions that have a binary answer. By way of example, one such question can be whether the person is over age 21 (e.g., for purposes of being able to consume alcohol). In this example, the answer is “yes” regardless of whether the wallet holder is 21, 23, or 45, and the answer can be verified as “yes” without disclosing the wallet holder's identity, birthdate, driver's license number, social security number, or any of a variety of other data that may become available when a driver's license is presented to verify age. In this example, the state of issuance of the digital wallet holder's driver's license (or some other trustworthy and credentialed entity entrusted with knowledge of the age of the digital wallet holder) could cryptographically sign and thus verify the “yes” answer, and the bar or restaurant serving alcohol could provide alcohol to the digital wallet holder with assurance that the holder is over 21 and can legally consume alcohol.

Other examples of zero-knowledge proofs are relevant to the monetary world, and include, for example, various responses to binary question. For example, a lender might be willing to extend a loan to a digital wallet holder if the holder's bank balance is above a certain minimum (say $3,000) and the holder's credit score is over a certain minimum (say 650). If the answer to those two questions is yes, the lender need not necessarily know that the holder's specific credit score is 631 and bank balance is $3,700. It is sufficient for the lender to know that a reputable data issuer cryptographically signs a yes/no statement that the holder's bank balance is above the set minimum and that the holder's credit score is also above the set minimum. Thus, zero-knowledge proofs provide adequate assurances, cryptographically signed by data issuers, without disclosing any information about the digital wallet holder other than the bare minimum necessary to satisfy a particular question or challenge.

Zero-knowledge proofs may be facilitated by communications between the digital wallet and the data issuer at the time a query is made. Alternatively, zero-knowledge proofs may be realized by way of advance obtaining of one or more cryptographic signatures of the data issuer prior to a point in time at which a query is made. Specifically, the data issuer may generate a cryptographic signature verifying and may permission the digital wallet to use the cryptographic signature as long as the query received by the digital wallet falls within the scope of what the data issuer can verify. Thus, for example, if the wallet holder has a credit score of 741, the data issuer may pre-issue a cryptographic signature that is valid for any query requesting a credit score above a number up to 740. The digital walled could then respond to a query with a cryptographically signed zero-knowledge proof without having a connection to the original data issuer at the time of providing the proof. If necessary, the cryptographic signature can be verified by the querying party separately.

Lenders must be willing to accept the information they receive in response to their queries in the report generated at step 90. Lenders are able to trust the information they receive due to the levels of trust imposed on the financial data sharing ecosystem as discussed above. Because the ecosystem relies on the trusted network and verifiable credential system provided by Sovern (or the like), the lenders are able to be assured that the limited data they are provided is accurate, despite consumers having more control over their financial and personal data than in the past. Furthermore, the assurances are provided to the lenders despite the fact that the personal and financial information is not maintained by a centralized repository of financial information (consumer reporting agency) as in past practice.

The lender is able to be assured that the information contained in the report generated at step 90 is accurate because of the chain of verifiable credentials established within the web of trust established among the identity owners, trust anchors, and trust hubs on the domain-specific trust framework. As one example, the lender is able to be assured that while the consumer controls and limits access to the consumer's bank account information, the trusted relationship between the consumer reporting agency (as, for example, the trust hub) and the financial institution (as, for example, the trust anchor) ensures that the report is based on accurate, up-to-date, and verifiable (and verified) information as of the time the report is generated. In conjunction with the report, the lender receives one or more verifiable credentials 60 that verify information such as that the consumer is who he or she purports to be, that the sources of information relied on for the report relate to the consumer and are accurate, and that the conclusions reached in the generated report are accurate. As necessary, the report may include verifiable credentials 60 verifying that the trust anchor or trust hub has verified the necessary verifiable credentials 60 of other network entities in generating the report at step 90.

Once the report is generated at step 90, an report consent receipt may be generated that records how the consumer's report and the information contained therein will be used, such as by the lender in evaluating the consumer's creditworthiness for extending the proposed loan or other extension of credit. Additionally, a link contract may be created at step 94, which link contract governs the lender's access to and use of the consumer data and reports in the manner consented by the consumer. Then, at decision block 96, a determination is made as to whether to deliver the generated report to the lender (recognizing that the lender will likely refuse to extend credit in the absence of the report). The report is delivered to the lender at step 98, whereupon the borrower may log out of the application or wallet until such time as the consumer again wishes to use the wallet to review or provide decentralized access to financial information about the consumer.

At the end of any session, the wallet or application providing access to the wallet may invite the consumer or borrower to view their data and/or reports. In this manner, a consumer reporting agency may satisfy its obligation as a consumer reporting agency to offer its reports to its consumers.

In some embodiments, a generated report may be automatically updated with any changed information based upon the link contract rights granted at step 94. Thus, if the consumer has granted rights to updated reports to the lender, such updated reports may be automatically made available. In contrast, if the consumer has not granted such rights, then the lender will not be able to view updated reports or information without first obtaining authorization and an updated permission or link contract from the consumer.

The data wallet that provides the consumer with control over and managed sharing of the consumer's financial data and information in a distributed manner may be implemented and may operate in a variety of fashions. As one illustrative example, an application operating the data wallet and providing the agent features to the consumer may be operated as a web-based application running on a remote server and operated over a secured (e.g., password-protected or biometric-protected website). As another illustrative example, the data wallet and agent features may be provided as a mobile app adapted to operate on mobile devices such as smart phones and tablets. In such embodiments, the mobile app may connect to and cooperate with a remote server to provide certain aspects of the service, including obtaining of any necessary verifiable credentials 60 or authentication of existing verifiable credentials 60.

In some embodiments, the data wallet and data control services are provided as part of a financial management application operating on a remote server (e.g., web-based access), or as part of a financial management application operating on a local computer, or as part of a financial management application operating on a mobile device such as a tablet, smart phone, or laptop. In such embodiments, the data verification, reporting, and sharing features may represent only a subset of the features provided by the financial management application (such as reviewing and managing account balances and payments and the like). In some such embodiments, the consumer may already have an account active with a service provider that acts as a trust hub or trust anchor, and that service provider may have previously been given appropriate information to allow the service provider to obtain account access and retrieve data sufficient to provide a variety of types of user-controlled reports for the credit decision-making process. Accordingly, the method illustrated in FIG. 7 could occur without the steps of creating a wallet and adding relevant accounts.

In such embodiments, a consumer, after logging in, could be brought to an update page where the consumer could verify that his or her accounts are updating successfully to ensure that any generated reports are accurate. In some instances, the consumer may be permitted to manually initiate an update process whereby the application uses the trust framework to obtain updated information for any reports.

When all applicable accounts relevant to a desired report are up-to-date within the application, the consumer may be brought to a page where the consumer may select which accounts to use in generating the report to be shared with the lender. Accordingly, the consumer is able to maintain strict control over what data or information is made available to the lender. The application may also allow the consumer to take various actions with respect to any generated reports, such as viewing the reports, disputing inaccurate data contained within the reports, viewing report status, viewing report dispute status, viewing consumer disclosures, and the like, in addition to any account management services which provided through the same application (e.g., viewing balances, account transfers, and the like).

The application may include a consent management platform that is capable of tracking consent events provided by the consumer at the application and data integration level. The application may also include an ability to write or save consent receipts for each consent event.

The service provider who acts as the trust hub may operate a link contract management platform that governs access to consumer data and reports as consented by the computer. A credential governance platform may prove partner entities (e.g., trust anchors) with the ability to build, issue, and verify credentials.

The distribution of consumer data to the individual consumer wallets in this fashion provides a mechanism by which consumers can use the data stored in their wallets to provide any necessary creditworthiness verification immediately. The lender need not resort to confirming creditworthiness from a traditional credit bureau (e.g., Experian, Equifax, TransUnion, etc.). Instead, because the data stored in the consumer's wallet is authenticated via the self-sovereign identity of the transactions on the trust network and via the verifiable credentials 60 and is further verifiable via the incorporated blockchain technology of the trust network, there is no need to resort to a query to a traditional credit bureau.

Instead, the consumer's digital wallet can be used to run any necessary calculations and reports at any time. A consumer can use the information contained in the wallet to generate an equivalent of a FICO credit score at any time and based on the most recent data. Additional reports, such as verification of income reports, verification of asset reports, transaction data based on cash flow reports, and any other similar reports may be generated at any time using a mobile device or, if additional computing power is necessary, using a cloud-assisted mobile device. As necessary, reports can be generated based on only a desired limited subset of relevant accounts.

Such systems facilitate consumer control of their data, in accordance with current trends such as Europe's General Data Protection Regulation (GDPR). Accordingly, consumers' data can be locked by default and the user must give consent before data can be accessed or used, and then only the portion necessary is actually accessed or used by the lender. Because the wallet contains all positive and negative information, any generated reports or credit scores can be trusted without the need of traditional credit bureaus. Accordingly, embodiments of the wallet provide the ability to generate credit scores anywhere in the world without the need of centralized credit bureaus. The credit scores are provided in a consumer-centric model using a single global app based on consumer permissioning.

Various different report models could be run within the wallet to generate different reports and scores to satisfy any desired criteria. When a lender wishes to obtain an applicable credit score, it queries the consumer's wallet (rather than querying a credit bureau), and the consumer provides permission for the app to use the underlying bank data contained in the wallet and the applicable credit score model, potentially in conjunction with a cloud-based model provider such as FICO. The lender could pay an appropriate fee to the trust hub which could be shared in part with the credit score model provider (e.g., FICO), which would be considered a premium verifiable credential.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A decentralized method for providing a verification of a consumer's creditworthiness without resort to a centralized credit bureau, the method comprising:
creating a digital wallet operating on a consumer computing device that includes a processor and non-transient memory store;
receiving an issued verifiable digital credential signed by a credential issuer acting as a trust anchor for a claim regarding a consumer's creditworthiness contained in the verifiable digital credential;
storing the verifiable digital credential within the digital wallet;
receiving a request for a verification of the consumer's creditworthiness from a lender; and
providing the verifiable digital credential, including the claim regarding the consumer's creditworthiness, to the lender using the digital wallet.

2. The decentralized method as recited in claim 1, further comprising a step of generating a consent receipt recording how information disclosed by the creditor will be used.

3. The decentralized method as recited in claim 1, further comprising a step of creating a consumer identification to serve as a decentralized identifier for the consumer.

4. The decentralized method as recited in claim 3, wherein creating a consumer identification is performed by the digital wallet.

5. The decentralized method as recited in claim 3, wherein creating a consumer identification is performed by the centralized credit bureau, and wherein the consumer identification is transmitted to the digital wallet.

6. The decentralized method as recited in claim 1, wherein the claim regarding the consumer's creditworthiness comprises a verified credit score.

7. The decentralized method as recited in claim 1, wherein the claim regarding the consumer's creditworthiness comprises a verification that the consumer's credit score exceeds a minimum value.

8. The decentralized method as recited in claim 1, wherein the claim regarding the consumer's creditworthiness comprises a zero-knowledge proof that the consumer's credit score exceeds a minimum value.

9. The decentralized method as recited in claim 1, wherein the claim regarding the consumer's creditworthiness comprises a zero-knowledge proof that the consumer has a bank balance in excess of a minimum value.

10. The decentralized method as recited in claim 1, wherein the claim regarding the consumer's creditworthiness comprises a zero-knowledge proof that the consumer has an income in excess of a minimum value.

11. A decentralized method for providing a verification of a consumer's creditworthiness that permits the consumer to verify creditworthiness without resort to a centralized credit bureau at a time of verification, the method comprising:
receiving, at a centralized credit bureau computer that is connected to a global network and that includes a processor, a login request from a new consumer;
creating a digital wallet for the new consumer using the processor;
delivering the digital wallet to the consumer over a network connection;
creating a consumer reporting agency (CRA) credential for the new consumer comprising a public-private key pair for a relationship between the CRA and the new consumer;
registering a new identifier on a trust network for the new consumer;
obtaining permission from the new consumer to share one or more claims sufficient to satisfy a lender request for a verification of the new consumer's creditworthiness;
issuing and digitally signing a verifiable digital credential containing a claim regarding the consumer's creditworthiness; and
delivering the claim regarding the consumer's creditworthiness to the digital wallet over the network connection such that the claim is available in the consumer's digital wallet for use on demand by the consumer.

12. The decentralized method as recited in claim 11, further comprising:
receiving permission from the new consumer over the global network to obtain information from a financial institution at which the new consumer has a financial account; and
using the permission from the new consumer to access the financial institution and obtain information regarding the new consumer's financial account.

13. The decentralized method as recited in claim 12, further comprising using the information regarding the new consumer's financial account to generate the claim regarding the consumer's creditworthiness, wherein the claim regarding the consumer's creditworthiness comprises a claim regarding income of the consumer.

14. The decentralized method as recited in claim 12, further comprising using the information regarding the new consumer's financial account to generate the claim regarding the consumer's creditworthiness, wherein the claim regarding the consumer's creditworthiness comprises a claim regarding an account balance of the consumer.

15. The decentralized method as recited in claim 12, wherein the claim regarding the consumer's creditworthiness comprises a zero-knowledge proof that the consumer's credit score exceeds a minimum value.

16. The decentralized method as recited in claim 12, wherein the claim regarding the consumer's creditworthiness comprises a zero-knowledge proof that the consumer's income exceeds a minimum value.

17. The decentralized method as recited in claim 12, wherein the claim regarding the consumer's creditworthiness comprises a zero-knowledge proof that an account balance of the consumer exceeds a minimum value.

18. A method for providing a verified zero-knowledge proof in response to a query, the method comprising:
receiving, at a user computing device having access to a digital wallet, a request for proof of information regarding a user;
using the user computer device to obtain permission from the user to provide a verifiable proof of information regarding the user;
accessing a response satisfactory to the requirements of the request for proof of information, wherein the response is cryptographically signed by a data issuer capable of verifying the information contained in the response; and
transmitting the response from the user computing device to a receiving device operated by an issuer of the request for proof of information regarding the user.

19. The method as recited in claim 18, wherein the response satisfactory to the requirements of the request for proof of information is previously obtained and stored within the digital wallet.

20. The method as recited in claim 18, wherein the response satisfactory to the requirements of the request for proof of information comprises information selected from the group consisting of:
verification of an age of the user;
verification that an age of the user exceeds a certain minimum;
verification that an age of the user is less than a certain maximum;
verification of a credit score of the user;
verification that a credit score of the user exceeds a certain minimum;
verification of an income of the user;
verification that an income of the user exceeds a certain minimum value;
verification of an account balance of the user;
verification that an account balance of the user exceeds a certain minimum value;
verification of a value of assets of the user; and
verification that a value of assets of the user exceeds a certain minimum value.
